(19) United States
(12) Patent Application Publication
(10) Pub. No.: US 2012/0054872 A1
(43) Pub. Date: Mar. 1, 2012

(54) SYSTEM FOR CONTROLLING USER INTERACTIONS IN SOCIAL NETWORKING ENVIRONMENTS

(76) Inventor: Naresh Belwal, Dehradun (IN)

(21) Appl. No.: 12/868,906

(22) Filed: Aug. 26, 2010

(51) Int. Cl. G06F 17/00; G06F 15/16

(52) U.S. Cl. 726/26

(57) ABSTRACT

A method for controlling user interactions in an Internet-based social networking system having a plurality of members provides for the assignation of privacy controls to contacts between a member and an invited contact of “friend” of the member. The member identifies a potential new network contact and designates privacy settings to be associated with network interactions with the potential contact. The member may also designate the new contact member to be a member of further groups or sub-groups within the member's group or universe of friends. A request is sent to the potential contact, asking the contact to be associated with the first member through the first member's address in the network with the previously designated privacy settings. If the invitation is accepted the designated privacy settings are immediately applied to the association between the potential contact and the first member, thus avoiding the possibility that nay interaction between the paties occurs without be subject to the privacy settings.

The present invention relates to a system for pre-emptively assigning privacy settings to contact/communication relationships between users of Internet and mobile communication networking platforms.

### BACKGROUND OF THE INVENTION

Social, professional and business-oriented networking sites and communities, such as Facebook, allow some low level of categorization of contacts or relationships developed through the network to allow a user control over the dissemination of information. Such control is applied after a relationship is established, and is normally insufficient to provide complete oversight to the on-line relationships. A user establishes an account in the network community, and is thus provided with a virtual address from which correspondence with other network community members can be sent, and to which correspondence from other community members can be received.

A community member is typically able to control the other network community members that have the ability to interact with the member through the member's address, by allowing only community members that have been “invited” by the user to join his/her more limited and personal community of associated members or “friends”. A community member can invite another member to join the member's group of contacts, and can impose limits on the degree of interaction between the invitee and other invitees. Facebook, for example, normally allows characterization of a user's contacts either as “friends”, or “friends of friends” and can assign the contacts into groups, with contact among friends being limited to the group level. Parameters can further be chosen to define the nature of postings at the user's address available to friends, depending on the group or groups to which they are assigned. Currently, however, users of such social, professional and business networking sites and communities are unable to categorize or control interaction and privacy parameters prior to sending or accepting an invitation to interact with another user. Thus, there have been reported cases of unwanted, uncalled for and, at times, highly embarrassing situations where, either purposely or unknowingly, correspondence or contact between a user and an intended recipient or group of recipients has been made available or sent to other members of the user's on-line community, due the inability of the user to pre-empt, pre-define or limit interaction between its contacts. In addition, a level of control at a group level may be insufficiently granular to accommodate control over the wide variety of communications and information that typically passes between and among a community of “friends”.

### BRIEF DESCRIPTION OF THE INVENTION

In accordance with the foregoing purpose, the present invention allows a network user to assign member contacts to a group that the user has defined and associate interaction parameters to the contact, both on the contact's individual as well as group level, to control the degree of interaction between the contact and other member's of the user's groups. Significantly, the user may assign a potential new contact to a group, and associate contact parameters with the potential new contact, prior to the time that the potential contact is actually engaged by the user and accepts an invitation to be associated with the user, such that from the moment the potential contact agrees to join the user's network, the privacy settings associated with the group to which the member is assigned, as well as the contacts personally-assigned privacy settings, will be applied to all contacts with the member.

### BRIEF DESCRIPTION OF THE FIGURE

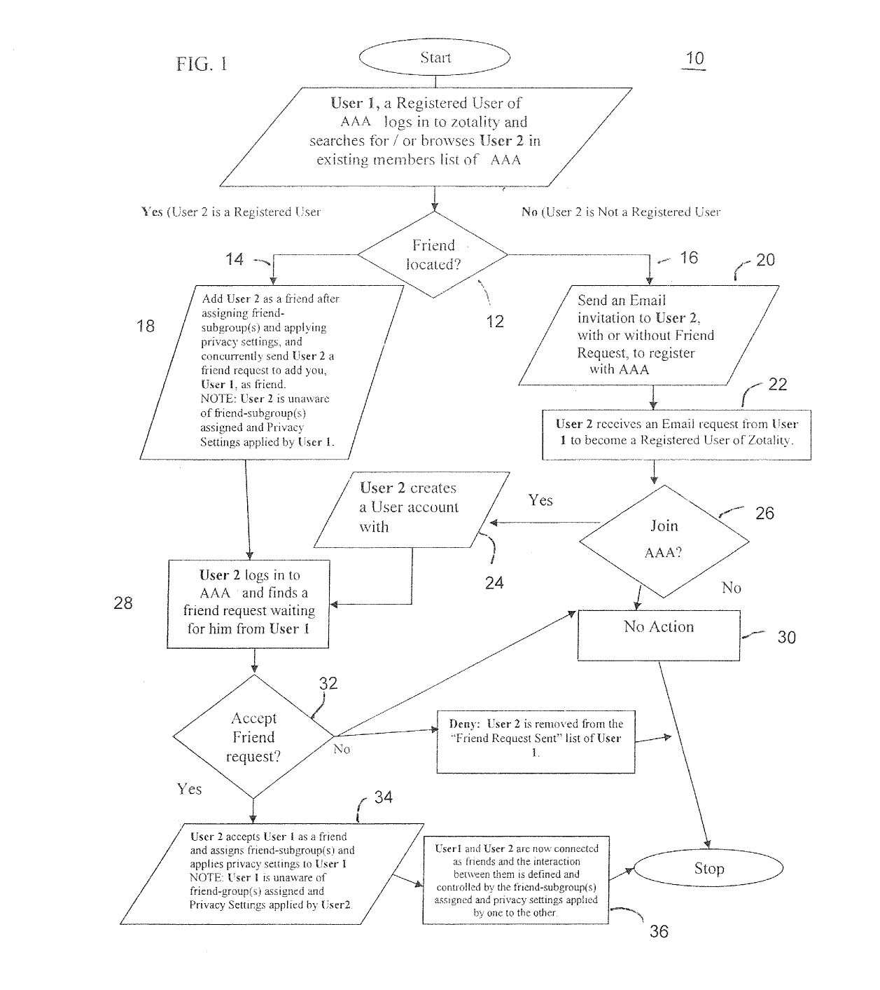

A fuller understanding of the invention will be accomplished upon consideration of the following description of an illustrative embodiment thereof, when reviewed in association with the annexed FIG. 1, presenting a flow chart of the operation of a system in which the invention is employed.

### DETAILED DESCRIPTION OF A PREFERRED EMBODIMENT

As depicted in FIG. 1, User 1, a member of the social/professional/business network AAA, seeks to add User 2 as a contact or “friend” to User 1's group or universe of contacts/friends at 10. Using his computer or mobile device. User 1 accesses a display of available privacy settings and chooses the settings he desires for the proposed contact. Typical content that may be available at User 1's page may include postings, as well as written content and other media, such as photos or videos. All of the foregoing may be generally referred to as available “content”. Setting choices may include, for example, whether User 2 can see all postings by User 1 and/or other members of the group or groups to which User is to be assigned by User 1; whether User 2 can view User 1's profile; whether User 2 can view User 1's albums; as well as any other privacy setting that the AAA network may make available to its users. Such settings may be common to all members of a group. or may be particular to a smaller “sub group” within a group, or only to a particular group member. For example, a setting may be that User 2's correspondence with User 1 is totally private; User 2 sees and can access nothing but User 1's communications to him and other members of User 1's group or groups cannot view any of User 2's communications. User 1 then saves the settings. User 1 may also assign User 2 to one or more of User 1's previously designated friend/contact groups and/or sub-groups.

At 12 Network AAA's server attempts to locate User 2 in the network's memory directory of users. User 2 is identified either as an existing member of network AAA (but not yet a contact for User 1) at 14, or as an AAA non-member which User 1 wishes to join the network at 16. If User 2 is an existing member, the system provisionally assigns him/her at 18 to User 1's desired group and sends User 2 an invitation to be a User 1 contact; the privacy settings that User 1 has defined and saved are immediately registered in connection with assignation. Simultaneously User 2 may receive a proposal from User 1 that User 1 be added as a contact or friend of User 2, thus allowing User 1 to view and interact with User 2's other contacts/friends separate and apart from User 2's relationship with User 1 and User 1's groups. User 2 is unaware of the privacy settings applied by User 1 to User 2's joining User 1's groups of contacts.

If User 2 is not located in the system database at 12 as present member of network AAA, branch 16 is followed, and an electronic invitation is sent by email to User 2 at 20/22, asking User 2 to join the AAA network, either with or without becoming a User 1 contact, If User 2 agrees to become a network member at 26, User 2 completes the formalities and an AAA network account is created for User 2 at 24. If User 2 does not wish to become a network member no action is taken. User 1 may be provided with a communication advising him that his invitation has been declined.

Whether User 2 is a new member of AAA, joining at 24, or was a current member that sent User 1's invitation at 18, when User 2 logs into his/her AAA account at 28. User 2 finds the invitation from User 1 and the request to add User 1 as a contact/friend to User 2, When User 2 logs into his/her account he receives the contact request from User 1 at 28, as has a pre-existing AAA member. The recipient User 2 then decides at 32 whether to accept the request. If the request is accepted, the privacy settings previously chosen by User 1 are immediately associated with the contact at 34. If User 2 was prompted to add User 1 as a friend/contact to User 2, User 2 can do so, assigning User 2's own desired privacy settings to User 1 to control the relationship between them through User 2's groups. In a likewise manner. User 1 will be unaware of the privacy settings applied by User 2. If User 2 is a new member, it can be prompted to consider sending a counter-request to User 1 to add User 1 as it's contact/friend, assigning User 1 to such groups as User 2 and applying User 2's own privacy settings to the invitation.

With the contact process being implemented. User 1 and User 2 are interconnected at 36 contacts in the AAA network, with the privacy settings that each has assigned to the relationship being implemented and applied as soon as the contact relationship is formed. If the friend/contact request from User 1 is declined, communications halt and User 2 is removed from a list of pending requests, ending the transaction.

I claim:

1. A method for controlling user interactions in an Internet-based social networking system having a plurality of members wherein a first member having a network member address controls the extent of access by a second member to content accessible at the address, comprising the steps of:
having the first network member identify a potential new network contact;
having the first network member designate privacy settings to be associated with network interactions with the potential contact;
sending a request to the potential contact to be associated with the first member through the first member's address in the network with the previously designated privacy settings; and
assigning the designated privacy settings to the association between the potential contact and the first member immediately upon the potential contact's accepting the invitation.

2. The method of claim 1, wherein the privacy settings to be associated with the potential contact are not disclosed to the potential contact.

3. The method of claim 1, wherein the potential contact designates privacy settings to be associated with network interactions with the first member through the potential contact's network address and sends a request to the first member to be associated with the potential contact through the potential contact's address in the network when the potential member accepts the invitation from the first member.

4. The method of claim 1, wherein the step of sending a request to the potential contact includes the step of determining whether the potential contact is a network member and, if not, sending an invitation to join the network concurrently with the association request.

5. The method of claim 1, wherein the first network group member has created groups for its contacts and designates the potential contact as a member of at least one of the groups prior to the time the request is sent to the potential contact, the assigned group setting being applied to the association between the potential contact and the first member immediately upon the potential contact's accepting the invitation.

6. The method of claim 5 wherein the privacy and group settings to be associated with the potential contact are not disclosed to the potential contact.

7. The method of claim 5 wherein the step of sending a request to the potential contact includes the step of determining whether the potential contact is a network member and, if not, sending an invitation to join the network concurrently with the association request.
